(19) United States
(12) Patent Application Publication
(10) Pub. No.: US 2011/0179896 A1
(43) Pub. Date: Jul. 28, 2011

(54) LEAD SCREW APPARATUS, LINEAR ACTUATOR, AND LIFT APPARATUS

(76) Inventors: Kenji HIRAKU, Kasumigaura (JP); Isao Hayase, Tsuchiura (JP)

(21) Appl. No.: 13/014,308

(22) Filed: Jan. 26, 2011

(30) Foreign Application Priority Data
Jan. 26, 2010 (JP) 2010-013957

(51) Int. Cl. F16H 25/22

(52) U.S. Cl. 74/424.9

(57) ABSTRACT

A lead screw apparatus includes a screw shaft having a spiral channel on an outer circumferential surface thereof, a plurality of rollers rotatable with contact with the spiral channel, and a cage rotatably supporting the rollers for conversion between relative rotation and linear motions between the screw shaft and the cage bi-directionally. The lead screw apparatus further includes a bearing and a holder 6 supported by the case for supporting the bearing. An inner ring of the bearing and the roller are integrally formed. An outer ring of the bearing has a protrusion on an outer circumferential surface thereof on a side closer to the screw shaft. Rollers of the bearing having a circular truncated cone shape are disposed in the bearing in a circumferential direction with substantially no gap. The outer ring has a thread part to shift the bearing and the roller.

### CROSS REFERENCE TO RELATED APPLICATION

This application claims the foreign priority benefit under Title 35, United States Code, §119(a)-(d) of Japanese Patent Application No. 2010-013957, filed on Jan. 26, 2010 in the Japan Patent Office, the disclosure of which is herein incorporated by reference in its entirety.

### BACKGROUND OF THE INVENTION

1. Field of the Invention

The present invention relates to a lead screw apparatus for converting a rotary motion and a linear motion, a liner actuator for linearly driving an object with the lead screw apparatus, and a lift apparatus with the liner actuator, and particularly to a lead screw apparatus for conversion between a rotary motion and a linear motion bi-directionally, a liner actuator for linearly driving an object by converting a rotary motion of, for example a motor, into a linear motion, and a lift apparatus with the linear actuator having a high power.

2. Description of the Related Art

There is a trend toward electric actuators from conventional hydraulic actuators in a field of actuators as a counter measure against environmental issues, particularly, global warming. The electric actuator is favorably evaluated because the electric actuator generates no environmental pollution because the electric actuator does not use hydraulic fluid which is necessary in the hydraulic actuators. In addition, electric-motorization by the electric actuator can increase efficiency and reduce power consumption as well as provide utilization of a regeneration power for further power consumption reduction. In a case where an internal combustion engine is used for a hydraulic actuator, it is necessary to locate the hydraulic actuator just near the internal combustion engine. On the other hand, when the internal combustion engine is used with the electric actuator, because a power generated by the internal combustion engine is once converted into an electric power, the electric actuator can be located away from the internal combustion engine, so that improvement in an operation environment at a local area, i.e., an actuator operating location, can be expected. In addition, a power from a grid including an electric power plant can be efficiently utilized by driving the electric actuator by a battery charged with a midnight power service.

The trend toward the electric actuator from the hydraulic actuator prevails into a field of linear actuators required to have such a great drive power that a hydraulic cylinder is frequently used in a lift apparatus such as construction equipment and press machines, and thus needs have been increasing for an electric linear actuator capable of generating a great drive power.

The electric linear actuator utilizes a rotary motion-linear motion conversion mechanism (lead screw apparatus). A ball screw has been utilized as the lead screw apparatus. The ball screw has a high power transmission efficiency because a rolling pair which has small balls is used as rolling elements. However, flaking frequently occurs due to a great Hertzian stress generated at a point contact at a small ball. Accordingly, if the ball screw is used in a great driving power application, a sufficient durability cannot be guaranteed against a required life.

A lead screw apparatus with a high drive power with a rotary motion-liner motion conversion mechanism having rolling pairs by line contact has been proposed which can reduce the Hertzian stress to increase durability against flaking. For example, JP 61-286663A and JP 04-129957U disclose lead screw apparatuses capable of providing line contact between a roller and a screw shaft in which a plurality of rollers are rotatably supported through a rolling bearing by a roller cage corresponding to a nut on a screw shaft, the rollers having axes of rotation disposed in a plane substantially in parallel with the center axis of the screw shaft outside the screw shaft. In addition, JP 6-17717 B and JP 62-91050U disclose lead screw apparatuses having a roller cage as a nut for a screw which rotatably supports a plurality of rollers through bearings in order to provide line contact between the rollers and the screw shaft in which the rollers have axes of rotation, disposed in a plane substantially orthogonal with a center axis of a lead screw, intersecting or passing near a center axis of a lead screw.

In the conventional lead screw apparatuses, there may be a case where the line contact cannot be maintained due to a partial contact between the roller and the screw shaft which may be caused by errors in dimensions of structural elements, assembling, and the like. Therefore, it is desirable that the lead screw apparatus is provided with a partial contact preventing mechanism for a surer line contact. However, when the lead screw apparatus is provided with a partial contact preventing mechanism, the lead screw apparatus will have a larger size and a manufacturing cost will increase.

### SUMMARY OF THE INVENTION

The present invention may provide a lead screw apparatus having the partial contact preventing mechanism between the roller and the screw shaft in which a size increase and a manufacturing cost increase are suppressed, a linear actuator, and a lift apparatus including the leas screw apparatus.

A first aspect of the present invention provides a lead screw apparatus comprising: a screw shaft having a spiral channel on an outer circumferential surface thereof; a plurality of rollers configured to revolve around the screw with contact with the spiral channel; a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; and bearings configured to rotatably support the rollers, each of the bearings including an outer ring supported by the roller cage and an inner ring part connected to each of the rollers. The roller and the inner ring part are formed of an integral one piece member.

A second aspect of the present invention provides a lead screw apparatus comprising: a screw shaft having a spiral channel on an outer circumferential surface thereof; a plurality of rollers configured to revolve around the screw with contact with the spiral channel; a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; bearings configured to rotatably support the rollers, each of bearings including an outer ring supported by a holder supported by the roller cage. The outer ring including a protrusion on an outer circumference thereof on a side of the outer circumference closer to the screw shaft, and the holder abuts the protrusion from a side farther than the protrusion from the screw shaft.

A third aspect of the present invention provides a lead screw apparatus comprising: a screw shaft having a spiral channel on an outer circumferential surface thereof; a plurality of rollers configured to revolve around the screw with contact with the spiral channel; and a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; bearings, each including an outer ring supported by the roller cage and a plurality of tapered rollers, configured to rotatably support the rollers. The tapered rollers are disposed on an inner circumferential surface in a circumferential direction of the outer ring with substantially no gaps so that adjoining rollers of the tapered rollers can contact with each other.

A fourth aspect of the present invention provides a lead screw apparatus comprising: a screw shaft having a spiral channel on an outer circumferential surface thereof; a plurality of rollers configured to revolve around the screw with contact with the spiral channel; and a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; and bearings, each including an outer ring supported by the roller cage, configured to rotatably support the rollers. The outer ring and the holder include a thread part configured to allow the outer ring to be screwed with the holder to allow the roller to shift in an axial direction of a rotation axis of the roller.

A fifth aspect of the present invention provides a linear actuator comprising: the lead screw apparatus according to the first aspect; and a rotational motor including a case side and an output side, wherein the output side is rotatable relative to the case side and coupled to the screw shaft, and the rotational motor generates rotation of the screw shaft relative to the roller cage to generate a linear motion of the roller cage.

A sixth aspect of the present invention provides a lift apparatus comprising: a support side; a movable side; and the linear actuator as claimed in claim 11. The case side is connected to the support side and the output side is connected to the movable side.

The present invention may provide a linear actuator with a partial contact preventing mechanism for preventing a partial contact between the roller and the screw shaft in which increase in a size and a manufacturing cost are suppressed, a linear actuator, and a lift apparatus having the lead screw apparatus.

### BRIEF DESCRIPTION OF THE DRAWINGS

The object and features of the present invention will become more readily apparent from the following detailed description taken in conjunction with the accompanying drawings in which:

FIG. 1 is a side view of a lead screw apparatus according to a first embodiment of the present invention;

FIG. 2 is a front view of the lead screw apparatus according to the first embodiment of the present invention;

FIG. 3 is a top view of the lead screw apparatus according to the first embodiment of the present invention;

FIG. 4 is a bottom view of the lead screw apparatus according to the first embodiment of the present invention;

FIG. 5 is a cross-sectional view taken along A-A in FIG. 3;

FIG. 6 is a top view of a main roller assembly and swing pins as disposed as shown in FIG. 3;

FIG. 7 is a cross-sectional view of the main roller assembly and the screw shaft taken along B-B in FIG. 3 as disposed as shown in FIG. 3;

FIG. 8 is an outline view of the main roller assembly when viewed from a direction of the swing axis;

FIGS. 9A to 9C are cross-sectional views of the main roller assembly to illustrate an operation of a partial contact preventing mechanism, wherein FIG. 9A shows a status of generation of a clockwise rotation moment on the swing axis due to partial contact at a tip of a thread, FIG. 9B shows a status of generation of a counterclockwise rotation moment on the swing axis due to partial contact at a base side of the thread, 9C shows a status of generation of no clockwise rotation moment on the swing axis due to contact at a middle portion of the thread;

FIG. 10 is a cross-sectional view, taken along C-C in FIG. 4, of an auxiliary roller assembly and the screw shaft as disposed as shown in FIG. 4 when viewed upside-down;

FIG. 11 is a cross-sectional view of the lead screw apparatus according to a second embodiment of the present invention;

FIG. 12 is an outline view of the main roller assembly of the lead screw apparatus according to a third embodiment of the present invention when viewed from a rotation axis direction;

FIG. 13 is a cross-sectional view of the main roller assembly according to a fourth embodiment of the present invention;

FIG. 14 is an outline view of a linear actuator according to a fifth embodiment of the present invention; and

FIG. 15 is an outline view of a lift apparatus (construction equipment) according to a sixth embodiment of the present invention.

The same or corresponding elements or parts are designated with like references throughout the drawings.

### DETAILED DESCRIPTION OF THE INVENTION

With reference to drawings will be described a first embodiment of the present invention on which other embodiments based.

### First Embodiment

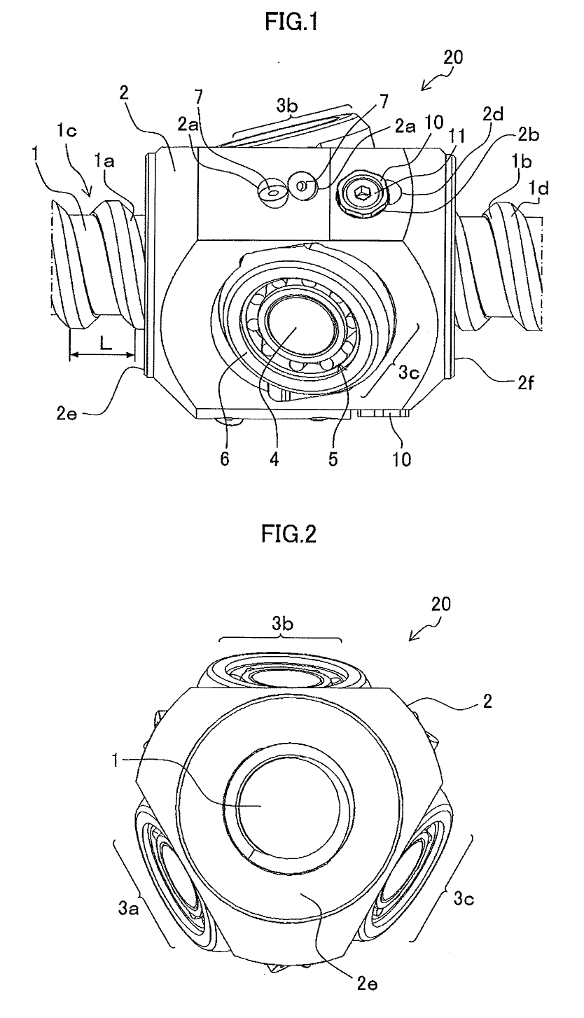

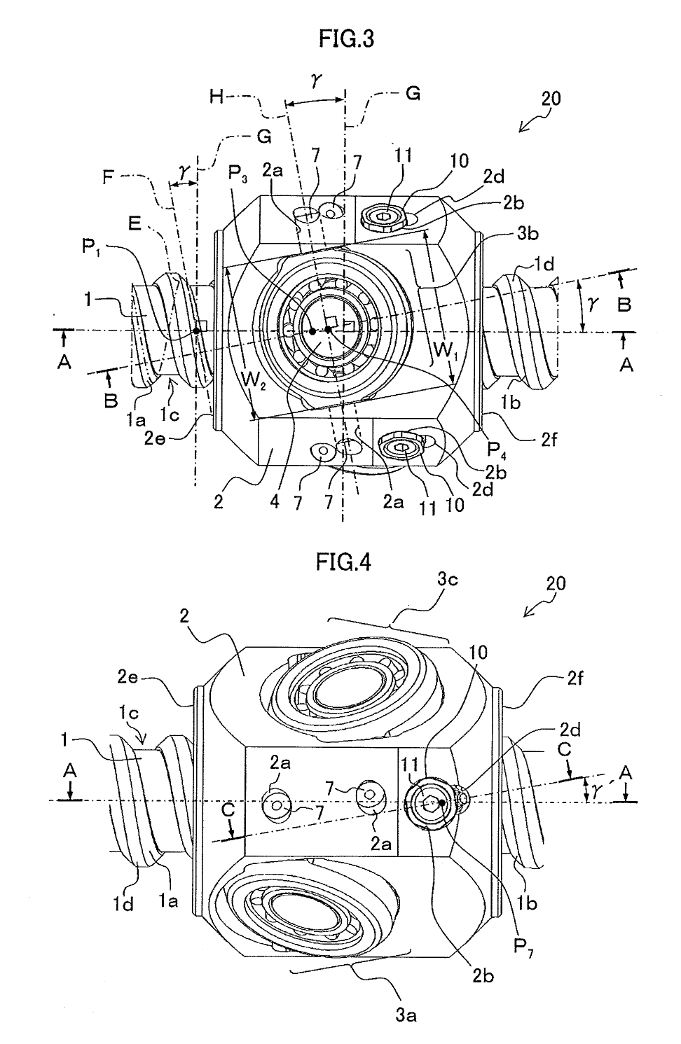

A lead screw apparatus 20 will be described as a first embodiment. FIG. 1 is a side view of the lead screw apparatus 20. FIG. 2 is a front view of the lead screw apparatus 20. FIG. 3 is a top view of the lead screw apparatus 20. FIG. 4 is a bottom view of the lead screw apparatus 20. The lead screw apparatus 20 includes a screw shaft 1 having a spiral channel 1c formed on an outer circumference surface of the screw shaft 1 to have a trapezoid cross section, a cage (roller cage) 2 through which the screw shaft penetrates between end faces 2e and 2f, and a plurality of, for example three, main roller assemblies 3a, 3b, and 3c mounted in the cage 2 at angular intervals of 120 degrees in a circumferential direction of the screw shaft 1 at distance intervals of one third of a lead L of the spiral channel 1c.

A side surface on a left side of the spiral channel 1c shown in FIGS. 1, 3, and 4 is a frank surface 1a and a side surface on a right side of the spiral channel 1c is a frank surface 1b. In other words, a right side surface of a thread 1d forming the spiral channel 1c is the frank surface 1a, and a left side surface of the thread 1d is the frank surface 1b. The spiral channel 1c has a trapezoid cross section of which width decreases toward a center axis of the screw shaft 1.

As shown in FIG. 1, the main roller assembly 3c includes a main roller 4, a conical roller bearing 5 for rotatably supporting the main roller 4, swing pins 7, and a holder 6 supported through the swing pins 7 for supporting the conical roller bearing 5. Other main roller assemblies 3a and 3b have the same structure as the main roller assembly 3c has.

As shown in FIG. 3, the main roller assembly 3b (holder 6) is mounded on the cage 2 through two swing pins 7. The two swing pins 7 are fitted into swing pin holes 2a provided in the cage 2. Other main roller assemblies 3a and 3c have the same structure. Center axes of the two swing pins 7 are aligned with a same axis (common axis). As a result, each of the main roller assemblies 3a, 3b, and 3c are capable of swing motion around the same axis. A dimension W₁ between two surfaces in the cage 2 and a dimension W₂ between two surfaces in the main roller assembly 3b (3a and 3b) are controlled to reduce gaps in the center axis of the swing pins 7 between the cage 2 and the main roller assembly 3b (3a and 3c) by a high accuracy processing. This prevents a position of each of the main controller assemblies 3a, 3b, and 3c from largely varying in the center axis direction of the swing pins 7 (in a swing axis direction).

The cage 2 is provided with auxiliary roller insertion holes 2b with arc-shape notches 2d, the number of which is the same as that of the main roller assemblies 3a, 3b, and 3c. Inserted into the auxiliary roller insertion notch 2d with the arc-shape notches 2d is an auxiliary roller assembly 8 (mentioned later) which is fixed with an adjust nut 10 and a rock nut 11 for fixation after adjustment of a depth of the auxiliary roller assembly 8 in the auxiliary roller insertion hole 2b.

As shown in FIG. 3, a spiral at an approximately half depth of the spiral channel 1c on the frank surface 1a is regarded as a representative spiral having a lead L which is the same as that of the screw shaft 1. It is assumed that an intersection of the representative spiral E with a plane G normal to the center axis of the screw shaft 1 is a point P₁. In addition, it is assumed that a tangential line at the point P₁ between the frank surface 1a and the representative spiral E is defined as a tangential line F. Further, an angle between the tangential line F and the plane G is a lead angle γ. An extension line (swing axis) H of a center axis of the two swing pins 7 also has an angle with the plane G normal to the screw shaft 1 which angle is equal to the lead angle γ. The representative spiral E is on an imaginary sleeve including a point P₃ in a line contact section and having a center axis which is common to (aligned with) the screw shaft 1, has the lead L which is the same as the screw shaft 1, and passes the point P₃.

A point P₄ is a middle point of a line segment in the extension line (swing axis) H where the extension line intersects the main roller 4. An angle between a center axis of the screw shaft 1 and a plane passing through the point P₄ and being normal to the extension line (swing axis) H, is equal to the lead angle γ.

The point P₃ is an intersection between the representative spiral E and the plane G normal to the center axis of the screw shaft 1 like the point P₁ and apart from the point P₁ by a distance twice the lead L (see FIG. 1). A plane including the center axis of the screw shaft 1 intersects, at the point P₃, a plane passing through the point P₄ and being normal to the extension line (swing axis) H. The plane passing through the point P₄ and being normal to the extension line (swing axis) H orthogonally intersects, the frank surface 1a, particularly, the representative spiral E at the point P₃. The frank surface 1a contacts with the main roller 4 along the contact line section at the point P₃.

As shown in FIG. 4, the arc-shape notches 2d is provided such that an inner wall of the auxiliary roller insertion hole 2b is notched and disposed in a direction which is inclined by an angle γ′ from a plane including the center axis of the screw shaft 1 and being in parallel to a center axis of the auxiliary insertion hole 2b. The plane including the center axis of the screw shaft 1 and being in parallel to a center axis of the auxiliary insertion hole 2b intersects the plane passing through a center of the arc-shape notch 2d and being inclined by the angle γ′ at a point P₇. At the point P₇ the frank surface 1b contacts with the auxiliary roller assembly 8. The angle γ′ may be substantially equal to the lead angle γ. However, the angle γ′ is not always equal to the lead angle γ, but may be different from the lead angle γ.

FIG. 5 shows a cross-sectional view taken along line A-A in FIG. 3. The main roller 4 contacts with the frank surface 1a at the point P₃. The auxiliary roller 12 of the auxiliary roller assembly 8 contacts with the frank surface 1b at a point P₇. Because each of the main roller assemblies 3a, 3b, and 3c has the main roller 4, the screw shaft 1 is supported by the three main rollers 4 at three points from a side of the frank surface 1a. Similarly, because there is provided the three auxiliary roller assemblies, the screw shaft 1 is supported by the auxiliary rollers 12 of each of the three auxiliary roller assemblies 8, i.e., at a total three points. This keeps the cage 2 away from the screw shaft 1 without contact.

Each of the main roller assemblies 3a, 3b, and 3c includes the main roller 4, the conical roller bearing 5, and a holder (main roller holder) 6 as shown by the example of the main roller assembly 3b. Between the cage 2 and each of the main roller assemblies 3a, 3b, and 3c gaps are provided to avoid interference between the cage 2 and each of the main roller assemblies 3a, 3b, and 3c within a swing angle range of the swing motion.

The main roller 4 is provided with an end surface 4b facing screw threads 1d of the screw shaft 1 and is hollowed like a surface shape of a concave mirror to be apart from the screw thread 1d without contact.

In addition, the main roller 4 is provided with a rolling contact surface 4a. The rolling contact surface 4a has a side surface of a circular truncated cone. Along a generating line of the circular truncated cone of the rolling contact surface 4a, the rolling contact surface 4a contacts with the frank surface 1a of the screw shaft 1 through line contact. The main roller 4 has a rolling contact surface 4a at the side wall having a shape of a circular truncated cone, and the rolling contact surface 4a contacts with the frank surface 1a through a linear contact line section. The swing axis H is substantially orthogonal with B-B cross section (plane) which is orthogonal with the representative spiral E (the frank surface 1a). The swing axis H is a tangential line at the point P₃ of the representative spiral E.

The points P₁, P₂, and P₃ on the frank surface 1a are points through which the representative spiral E (see FIG. 3) passes, and FIG. 5 illustrates a condition of contact between the frank surface 1a and the rolling contact surface 4a. The main roller 4 can revolve around the screw shaft 1 while the rolling contact surface 4a contacts with the frank surface 1a. The cage 2 supports the main roller 4 rotatably. The lead screw apparatus 20 provides conversion between a relative rotation motion of the screw shaft 1 to the cage 2 and a relative linear motion in an axial direction of the screw shaft 1 of the screw shaft 1 to the cage 2 bi-directionally.

The main roller 4 is rotatably supported by the holder 6 through the conical roller bearing 5. The conical roller bearing 5 rotatably supports the main roller 4, and a bearing outer ring 5b supporting the conical roller bearing 5 is supported by the cage 2. The conical roller bearing 5 includes a plurality of taper rollers (circular conical roller) 5a having a circular truncated cone shape, a retainer (not shown) for retaining the adjoining taper rollers 5a in a separate state, a bearing inner ring 5c fixed to the main roller 4 by fitting the inner circumferential surface thereof into an outer circumferential surface of the main roller 4. An outside in a radial direction of the screw shaft 1 of the holder 6 is provided with a protrusion 6b. An inside in the radial direction of the screw shaft 1 of the protrusion 6b abuts the bearing outer ring 5b of the conical roller bearing 5, which prevents the bearing outer ring 5b and the conical roller bearings 5 from being removed outwardly in the radial direction of the screw shaft 1. Near the rolling contact surface 4a of the main roller 4a hook 4c is provided. An outside, in the radial direction, of the screw shaft 1 abuts the inner ring 5c of the conical roller bearing 5, which prevents the main roller 4 from being removed toward outside in a radial direction of the screw shaft 1.

Auxiliary roller assemblies 8 are arranged in the cage 2 in a circumferential direction of the screw shaft 2 with an angular interval of approximately 180 degrees and are opposite to the main roller assemblies 3a, 3b, and 3c through the screw shaft 1, respectively. Three auxiliary roller assemblies 8 are provided similar to the main roller assemblies 3a, 3b, and 3c. More specifically, the auxiliary roller assemblies 8 are assembled in the cage 2 with an approximately 120 degrees angular interval in the circumferential direction of the screw shaft 1 and with shift of approximately one third of the lead L (see FIG. 1) in the axial direction of the screw shaft 1. Between end surfaces 2e and 2f disposed apart from each other in the axial direction of the screw shaft 1, the main roller assemblies 3a, 3b, and 3c are disposed on a side closer to the end surface 2e than the end surface 2f of the cage 2, and the auxiliary roller assemblies 8 are disposed on a side closer to the end surface 2f than the end surface 2e.

The auxiliary roller assembly 8 includes an auxiliary roller 12 rotatable with contact with the frank surface 1b of the screw shaft 1, needle rollers 13 for rotatably supporting the auxiliary roller 12, an auxiliary roller shaft 14 serving as a rotation axis of the auxiliary roller 12, an auxiliary roller holder 15 for rotatably supporting the auxiliary roller shaft 14, and a fixing nut 16 for fixing the auxiliary roller shaft 14 to the auxiliary roller holder 15. The auxiliary roller assembly 8 is inserted into the auxiliary roller insertion hole 2b so as to insert, in the arc-shape notch 2d, a side where the fixing nut 16 of the auxiliary roller shaft 14 is fixed. An inner wall of the auxiliary roller insertion hole 2b is threaded to provide adjustment of a position in a depth direction of the auxiliary roller insertion hole 2b in the auxiliary roller holder 15 so as to contact the auxiliary roller 12 with the frank surface 1b (auxiliary roller position adjustment function). In addition, a lock nut 11 is provided to prevent the position of the adjust nut 10 from shifting as a result of looseness (rotation) of the adjust nut 10. The lock nut 11 fixes the adjust nut 10 to prevent the adjust nut 10 from being loosen by pressuring the adjust nut 10 on the auxiliary roller holder 15. A plurality of the auxiliary rollers 12 roll on the frank surface 1b facing the frank surface 1a. The auxiliary roller shaft (rotating shaft) 14 for the auxiliary roller 12 is fixed to the cage 2. An auxiliary roller position adjustment function of the auxiliary roller shaft 14 fixed to the cage 2 capable of shifting a fixing position of the auxiliary roller 14 is provided using the adjust nut 10 and the lock nut 11, and the like. The auxiliary roller position adjustment function provides backlash adjustment between the screw shaft 1 and the auxiliary roller 12 in the axial direction and radial direction of the screw shaft 1.

The auxiliary roller 12 of the auxiliary roller assembly 8 line-contacts with the frank surface 1b of the screw shaft 1 on a line including a point P₇ on the frank surface 1b of the screw shaft 1. The auxiliary roller 12, being smaller than the main roller 4, has a smaller withstanding load than the main roller 4. Inversely, the main roller 4, being larger than the auxiliary roller 12, has a higher withstanding load. This allows the force acting on the cage 2 in a direction from the end surface 2f to the end surface 2e to be larger than a force acting in a direction from the end surface 2e to the end surface 2f. When it is desired to make a force acting on the cage 2 in a direction from the end surface 2e to the end surface 2f larger, the main roller assemblies 3a, 3b, and 3c are additionally provided in place of the auxiliary roller assembly 8.

Next the swing motion of the main rollers 3a, 3b, and 3c will be described.

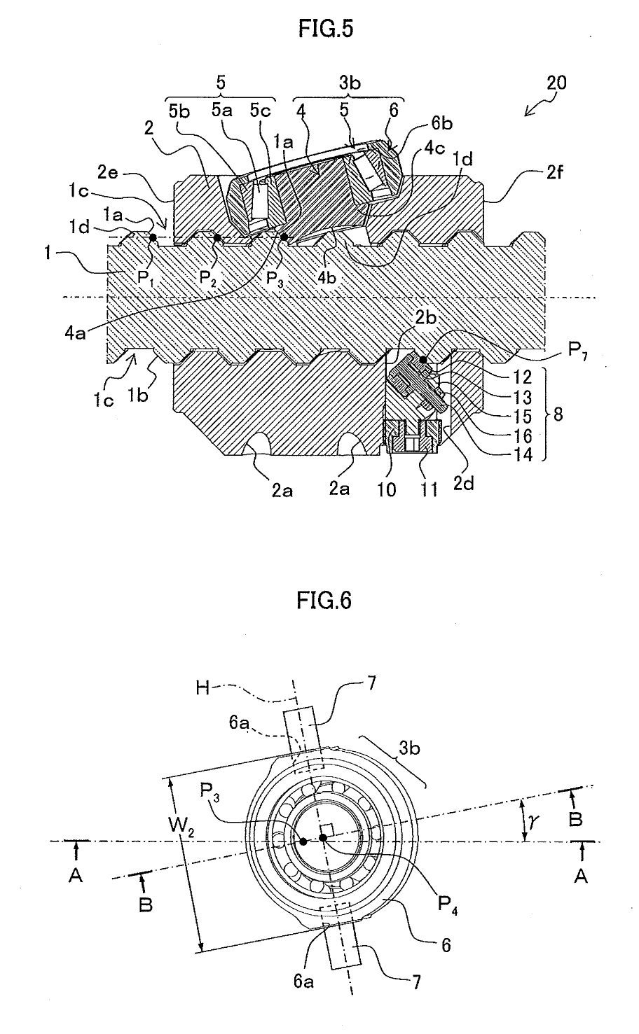

FIG. 6 illustrates only the main roller assembly 3b and the swing pins 7 taken from the arrangement shown in FIG. 3 in which a position relation shown in FIG. 3 is kept. The swing pins 7 are fitted into two swing pin holes 6a formed in the holder 6 to have the same axis, respectively, and support the main roller assembly 3b on a common axis (swing axis) H. The plane (B-B cross section) normal to the common axis (swing axis) H is inclined with an angle equal to the lead angle γ from the center axis of the screw shaft 1. Each of the swing pins 7 is fitted into the swing pin hole 2a of the cage 2 (see FIG. 3) and the swing pin hole 6a of the holder 6 so as to extend therebetween to provide the swing axis H for swinging each of the main roller assemblies 3a, 3b, and 3c relative to the cage 2 and has a function of transferring the load between the cage 2 and each of the main controller assemblies 3a, 3b, and 3c.

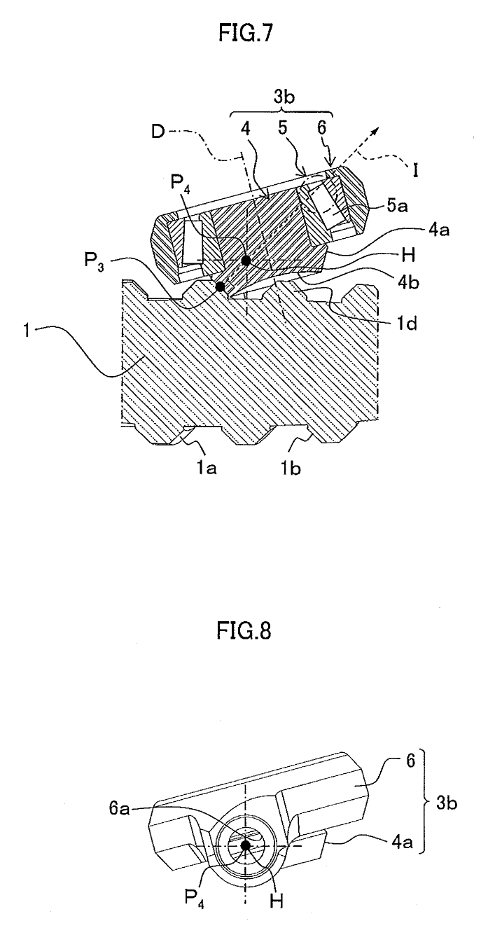

FIG. 7 is a cross sectional view taken along line B-B in FIG. 3 to illustrate the main roller assembly 3b and the screw shaft 1 which are taken from arrangement shown in FIG. 3 in which the position relation is kept. The B-B cross section taken along the line B-B is inclined by the lead angle γ from the center axis of the screw shaft 1. In addition, the B-B cross section includes a rotation axis of the main roller 4 as shown in FIG. 7. The B-B cross section is provided along the rotation axis D of the main roller 4. The rotation axis D is inclined in the radial direction of the screw shaft 1 toward a contact section side between the rolling surface 4a and the frank surface 1a. This structure allows the end surface 4b of the rolling plane 4a to be inclined in such a direction as to avoid interference with the thread 1d on just right side of the thread 1d by one pitch and covers above the thread 1d on just right side of the thread 1d by one pitch. This structure allows the rolling surface 4e to have a larger curvature radius and thus can largely and surely reduce the Hertz plane pressure generated at the contact line section, which extends a flaking life time in addition to the automatic center adjustment mechanism that surely provides line contact. The end surface 4b is formed to have a hollow surface, which can make the radius of curvature of the rolling surface 4a large also.

The rotation axis (center axis) D of the main roller 4 is approximately in parallel to the B-B cross section orthogonal to the representative spiral E at one point P₃, i.e., it can be said that the rotation axis (center axis) D of the main roller 4 is included in the B-B cross section. The rolling surface 4a is a side surface of a substantial circular truncated cone where an outer circumferential diameter on a cross section perpendicular to the axis decreases as a point of the outer circumferential diameter on the side surface goes along the rotation axis (center axis) D of the main roller 4 and approaches the center axis of the screw shaft 1.

In addition, the B-B cross section includes a linear section where the rolling surface 4a of the main roller 4 contacts with the frank surface 1a of the screw shaft 1, particularly, the point P₃ located at the middle of the section. The rolling surface 4a having the circular truncated cone line-contacts with the frank surface 1a. More specifically, a lead angle γ of each spiral passing through each point in the line contact section on the frank surface 1a in FIG. 7 is not constant, and only the representative spiral E having the lead angle γ equal to the cross angle γ between the B-B cross section and the center axis of the screw shaft 1 can contact with the rolling surface 4a which a circular cone at the point P₃ on the B-B cross section shown in FIG. 7. Contact points other than the contact point between the spiral passing through points other than the point P₃ shifts from the B-B cross section (paper face) in a direction perpendicular to the B-B cross section (paper face) in accordance with a difference between the lead angle of the spiral passing through the points other than the point P₃ and the lead angle γ at the point P₃. However, a quantity of shift from the B-B cross section (paper face) is small, so that it can be approximated that the contact line between the frank surface 1a and the rolling surface 4a is on a cross-sectional contour of the frank surface 1a (B-B cross section) in FIG. 7.

The point P₄ on the swing axis H is located on a side of the point P₃ away from the rotation axis D. The point P₄ is located between the rotation axis D and the point P₃. The point P₄ is disposed on a normal I on the frank surface 1a. In addition, the taper roller 5a are disposed so as to rolling across the normal I. The point P₄ where the swing axis H intersects the B-B cross section (plane) is on the B-B cross section (plane) is disposed on the normal (line) passing the point P₃ and intersecting the linear contact section substantially orthogonally or in the vicinity of the normal I.

FIG. 8 illustrates a view of the main roller assembly 3b shown in FIG. 6 when the main roller is viewed from an outside thereof in a direction of the swing axis H. The center axes of the swing pin holes 6a are aligned with the swing axis H and passing through the point P_{4.}

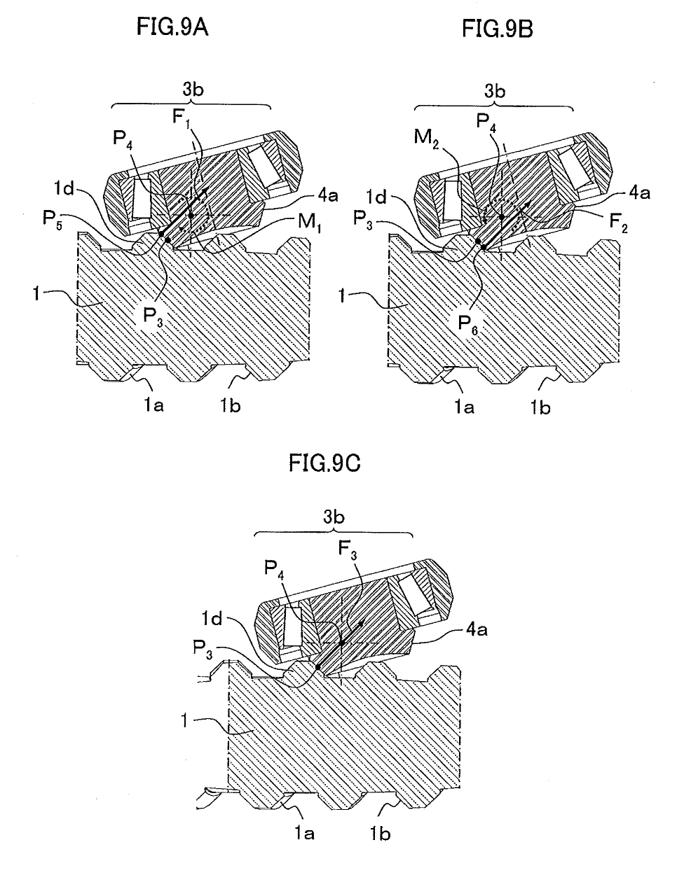

A principle of a partial contact preventing mechanism (automatic aligning mechanism) between the main roller 4 and the screw shaft 1 using swing motion of the main roller assembly 3 will be described with reference to FIG. 9A.

FIG. 9A shows a status in which a clockwise rotation moment M₁ is generated around the swing axis H due to occurrence of a partial contact at a point P₅ on a tip side of the thread 1d of the screw shaft 1. The partial contact occurs when the frank surface 1a is not in parallel to the rolling surface 4a due to, for example, a dimensional error. When the partial contact occurs at a point P₅ on a tip side over the point P₃ of the thread 1d, a contact force F₁ acting on the rolling surface 4a from the frank surface 1a is generated in a normal direction of the frank surface 1a at the point P₅ as a point of application from the screw shaft 1 to the main roller 4. As previously described, the point P₅ and the contact force F₁ are slightly shifted from the B-B cross section (outside paper face), the contact force F₁ shown in FIG. 9A should be the projected component on the B-B cross section. However, because a deviation component is very small and has substantially no effect if the deviation is neglected, the contact force F₁ shown in FIG. 9A is regarded as a net contact force

The contact force F₁ does not intersect the swing axis H (point P₄) and passes through a point deviated from the swing axis H (point P₄), so that a rotation moment M₁ occurs (is generated) around the swing axis H (point P₄). The rotation moment M₁ rotates the whole of the main roller assembly 3b clockwise, so that the frank surface 1a contacts with the rolling surface 4a on a side closer to the base of the thread 1d than the point P₅ (in a radial direction of the screw shaft 1, on the center axis side) also, for example, a point near the point P₃. When the contact situation is not in an extremely partial contact, as shown in FIG. 9B, but a point of application of resultant force of the contact force F₂ acting on the rolling surface 4a from the frank surface 1a is on the side closer to the base of the thread 1d than the point P₃, a rotation moment occurs (is generated) in the same direction of the rotation moment M₂, which automatically rotates (swing) the whole of the main roller assembly 3b, so that the point of the application of the resultant force of the contact force F₂ is shifted toward the tip side of the thread 1d.

FIG. 9B illustrates a situation in which a counterclockwise rotation moment M₂ occurs (is generated) around the swing axis H by occurrence of the partial contact at a point P₆ on the side of the base of the thread 1d. When the partial contact occurs at the point P₆ on a side closer to the base part of the thread 1d than the point P₃ of the thread 1d, the contact force F₂ acting on the rolling surface 4a from the frank surface 1a occurs (is generated) in a normal direction of the frank surface 1a at the point P₆ as the point of application from the screw thread 1 to the main roller 4. Because the contact force F₂ does not intersect the swing axis H (point P₄), but passes through a point deviated from the swing axis H (point P₄), a rotation moment M₂ occurs (is generated) around the swing axis H (point P₄). The rotation moment M₂ rotates the whole of the main roller assembly 3b counterclockwise, so that the frank surface 1a contacts with the rolling surface 4a on a side closer to the tip of the thread 1d than the point P₅ (in a radial direction of the screw shaft 1, on the center axis side) also, for example, a point near the point P₃. When the contact situation is not in an extremely partial contact, as shown in FIG. 9A, but when a point of application of resultant force of the contact force F₁ acting on the rolling surface 4a from the frank surface 1a is on the side closer to the base of the thread 1d than the point P₃, a rotation moment occurs (is generated) in the same direction of the rotation moment M₂, which automatically rotates (swing) the whole of the main roller assembly 3b, so that the point of the application of the resultant force of the contact force F₂ is shifted toward the tip side of the thread 1d.

FIG. 9C illustrates a situation in which no rotation moment is generated because the main roller 4 abuts the thread 1d at the point P₃ which is a middle point between the tip and base of the thread 1a. A point of application of a resultant contact force F₃ acting on the rolling surface 4a from the frank surface 1a occurs (is generated) at the point P₃ between the tip and the base of the thread 1d. The contact force F₃ is generated in a normal direction of the frank surface 1a at the point P₃ as a point of application from the screw shaft 1 to the main roller 4. The contact force F₃ is generated toward the swing axis H (point P₄) and is not deviated from the swing axis H (point P₄), so that no rotation moment occurs around the swing axis H (point P₄). Accordingly, the whole of the main roller assembly 3b does not rotate and the position thereof is stable and kept as it is. In addition the point of application of the resultant force F₃ on the rolling surface 4a from the frank surface 1a does not shift from the point P₃. Actually, the contact force F₃ on the rolling surface 4a from the frank surface 1a acts as a line-distributed load. Capability of maintaining the point of application of the resultant force of the line-distributed load at the point P₃, which is middle between the tip and base of the thread 1d, means that it is possible to provide a homogeneous distribution with an approximately constant value in the line-distributed load, so that a maximum value of the line-distributed load can be suppressed to a smaller value. A summary of description regarding FIGS. 9A, 9B and 9C is as follows:

The screw shaft apparatus according to the first embodiment has a function of providing line-contact situation with a low maximum contact pressure between the frank surface 1a and the rolling surface 4a by automatic swing motion of the main roller assembly 3b relative to the cage 2 until the rotation moments M₁ and M₂ become zero even if there is dimensional errors in the components such as the frank surface 1a and the rolling surface 4a. In addition, the screw shaft apparatus according to the first embodiment has the partial contact preventing mechanism (automatic aligning mechanism) for preventing a partial contact between the main roller 4 and the screw shaft 1. When a contact part between the main roller 4 and the screw shaft 1 deviates to an end of the linear contact section, the rotation moments M₁ and M₂ that rotate the holder 6 on the swing axis H by a force acting the main roller 4 through the contact part, which rotates (swing) the holder 6 in such a direction that the main roller 4 approaches the screw shaft 1 at the other end of the contact section. The main roller assemblies 3a and 3c have the same function and operation.

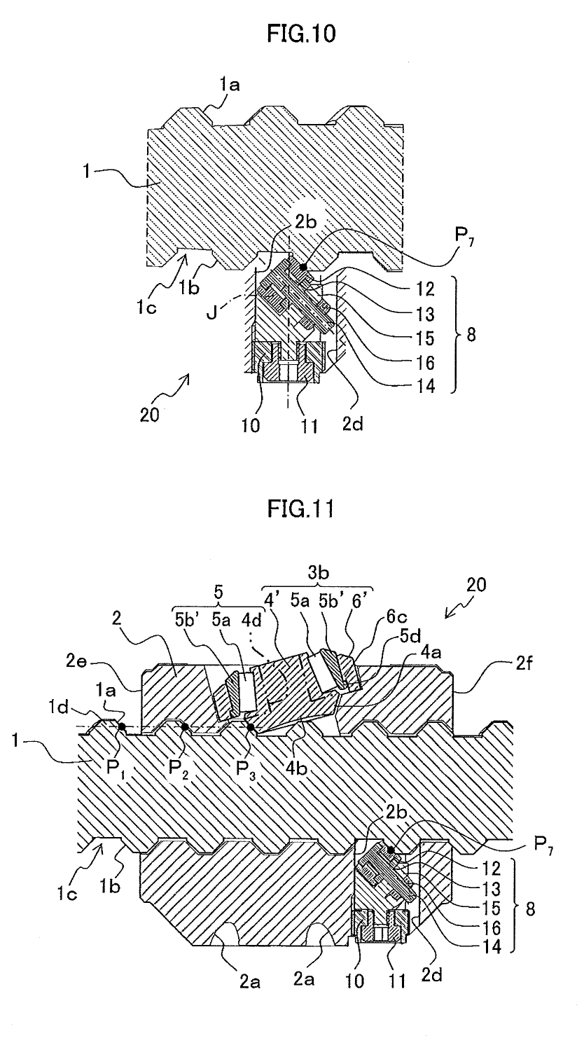

FIG. 10 is a cross-sectional view taken along line C-C in FIG. 4 viewed in direction indicated by arrows in FIG. 4 to illustrate the auxiliary roller assembly 8 and the screw shaft 1 taken from arrangement shown in FIG. 4 with positional relations kept. The cross-sectional view taken along line C-C is inclined from the center axis of the screw shaft 1 by the lead angle γ′. As shown in FIG. 10, a C-C cross section includes a rotational axis J of the auxiliary roller 12 which is a center axis of the auxiliary roller axis 14. In other words, the C-C cross section is taken along the rotation axis J of the auxiliary roller 12. In addition, the C-C cross section illustrates a linear section of line contact between the auxiliary roller 12 and the frank surface 1b of the screw shaft 1 as a point of P₇ located at a middle of the section. Accordingly, the auxiliary roller 12 contacts with the frank surface 1b in a line-contact situation. Because a cross-sectional contour of an outer circumferential surface of the auxiliary roller 12 has a small curvature such that diameters slightly increases from the end to the middle thereof, strictly, the auxiliary roller 12 contacts with the frank surface 1b on the right side of the spiral channel 1c of the screw shaft 1 at one point of P₇. This means that the C-C cross section in FIG. 4 is a plane intersecting the center axis at an angle of γ′ if it is assumed that a lead angle of a representative spiral E passing through the point P₇ on the frank surface 1b is γ′.

The auxiliary roller assembly 8 is inserted into the auxiliary roller insertion hole 2b formed in a radial direction of the cage 2. In addition, the arc-shape notches 2d are formed in the auxiliary roller assembly 8 to avoid interference with a protruding part of the auxiliary roller assembly 8. More specifically, the protruding part is an end of the auxiliary roller shaft 14 and the fixing nut 16. The auxiliary roller assembly 8 is restricted in rotation within the auxiliary roller insertion hole 2b with, for example, a key (not shown) to keep a rotation axis (center axis) J of the auxiliary roller 12 within the C-C cross section. The adjust nut 10 can shift (slidably fix) the auxiliary roller assembly 8 from an outer circumferential side of the cage 2 toward the inner circumferential side by that a male thread part is screwed into a female part of the auxiliary roller insertion hole 2b. In other words, a fixing point of the auxiliary roller assembly 8 can be adjusted. When the adjust nut 10 is fixed to the auxiliary roller assembly 8 by screwing the lock nut 11 into the auxiliary roller holder 15, the adjust nut 10 cannot be rotated, which fixes the auxiliary roller assembly 8 in the auxiliary roller insertion hole 2b in a direction from the outer circumferential side to the inner circumferential side of the cage 2.

According to the lead screw apparatus 20 as described above the cage 2 can be mounted on the screw 1 through the main rollers 4 and the auxiliary rollers 12 without backlash in the axial direction of the screw shaft 1 as follows:

For example, while a status is kept in which the end surfaces 2e and 2f of the cage 2 is vertical to the center axis of the lead screw 1 and three main rollers 4 simultaneously contact with the frank surface 1a as shown in FIG. 1, three auxiliary roller assemblies 8 are shifted by the adjust nuts 10 in an inner circumferential direction of the cage 2 to contact the auxiliary rollers 12 with the frank surface 1b in three directions, and the adjust nuts 10 are fixed with the lock nuts 11. In addition, when the adjust nuts 10 are fixed with the lock nuts 11 after the adjust nuts are further screwed from this situation, respectively, a constant quantity of preload can be added. When the adjust nuts 10 are fixed with the lock nuts 11 after the adjust nuts 10 are rotated in opposite directions by a predetermined rotation quantity, backlash is controlled toward a constant quantity. In other words, this prevents dispersion in a quantity of preload and the quantity of backlash due to accumulation of dimensional error of component parts.

The spiral channel 1c of the screw shaft 1 has a cross section of which channel width decreases toward the center axis of the screw shaft 1, and the rolling surface 4a of the main roller 4 that contacts with and rolls on the frank surface 1a has an approximately cone side surface of which a radial of a circle of a cross section perpendicular to the rotation axis (center axis) D decreases as a point on the circle goes toward the center axis of the screw shaft 1 along the rotation axis (center axis) of the main roller 4. Accordingly, a larger diameter part of the cone-shape roller 4 rolls on a spiral on an outer circumferential side of the frank surface 1a which is apart from the center axis of the screw shaft 1 and which has a larger rolling distance. A smaller diameter part of the cone-shape roller 4 rolls on a spiral on an inner circumferential side of the frank surface 1a and has a smaller rolling distance. In other words, local slips can be suppressed at all points along the line contact section, so that a life of the lead screw apparatus 20 can be extended and a high efficiency of the lead screw apparatus 20 can be provided.

As mentioned above, the lead screw apparatus includes a screw shaft having a spiral channel on an outer circumferential surface thereof; a plurality of rollers configured to roll on the spiral channel while revolving around the screw shaft; a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; and bearings configured to rotatably support the rollers. Each of the bearings includes an outer ring supported by the roller cage and an inner ring part connected to each of the rollers. The roller and the inner ring part are formed of an integral one piece member.

The lead screw apparatus 20 according to the first embodiment has been described. Next, other embodiments based on the first embodiment will be described.

### Second Embodiment

FIG. 11 is a cross-sectional view corresponding to FIG. 5 illustrating the lead screw apparatus 20 according to a second embodiment.

The lead screw apparatus 20 according to the second embodiment is different from the lead screw apparatus 20 according to the first embodiment in that a main roller 4′ is formed by integrating the main roller 4 with the circular roller bearing 5 shown in FIG. 5. This integrated structure can reduce the number of parts and increase accuracy in assembling. Accordingly a reliability of the lead screw apparatus 20 can be increased, and when this lead screw apparatus 20 is used in a linear actuator, higher accuracies in a positional control and a driving force control can be provided.

There is a second different point from the first embodiment in that the protrusion 6b of the holder 6 shown in FIG. 5 is replaced with a step part 6c formed on the holder 6′ on a side closer to the screw shaft 1. According to this, a protruding part 5b is formed on an end of a bearing outer ring 5b′ of the circular roller bearing 5 closer to the screw shaft 1. The holder 6′ is provided with a step part 6c on an inner side in diametrical direction of the screw shaft 1. An inner side in the radial direction of the screw shaft 1 of the step part 6c abuts the protruding part 5d from a side farther than the protruding part 5d from the screw shaft 1 to prevent the bearing outer ring 5b′, the circular roller bearing 5, and the main roller 4 from being removed therefrom in an outer diameter direction of the screw shaft 1.

Each of the bearings 5 includes the outer ring 5b′ supported by the roller cage 2 and an inner ring part 4d, serving as an inner ring of the bearing 5b′, connected to the roller 4′, wherein the roller 4′ and the inner ring part 4d are formed of an integral one piece member. Because the protrusion 6b of the holder 6 shown in FIG. 5 can be omitted, a far side of the holder 6′ from the screw shaft 1 can be omitted, so that the holder 6′ can be downsized. In addition, end surfaces of the holder 6′ and the bearing outer ring 5b′ on the far side from the screw shaft 1 can be tapered, so that the main roller assemblies 3a, 3b, and 3c can be downsized in addition to the holder 6′. Accordingly, a dimension of the lead screw apparatus 20 in diametrical direction can be decreased, and thus, a linear actuator using this lead screw apparatus 20 can be downsized.

### Third Embodiment

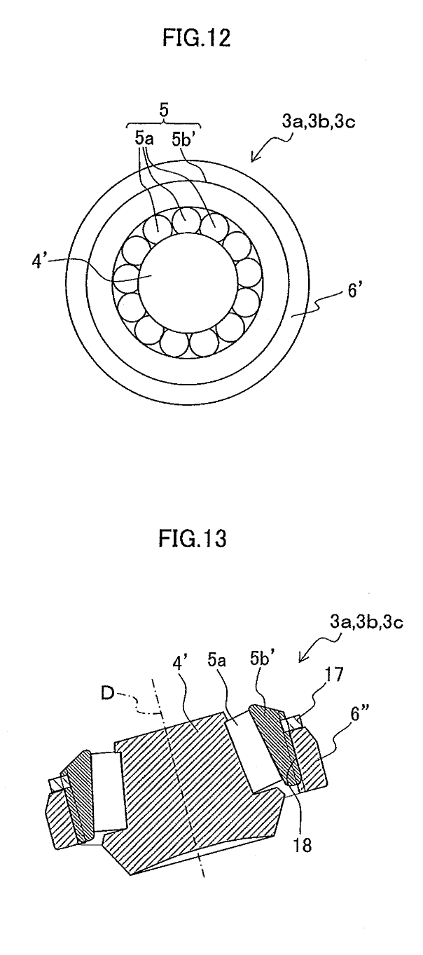

FIG. 12 is a view of the main roller assemblies 3a, 3b, and 3c mounted on a lead screw apparatus according to a third embodiment in which the main roller is viewed from a rotation axis thereof. The main roller assemblies 3a, 3b, and 3c according to the third embodiment is different from the main roller assemblies 3a, 3b, and 3c according to the first embodiment in that a plurality of the taper rollers 5a are disposed between the main roller 4′ and the bearing outer ring 5b′ with such gaps that any adjoining pair of the taper roller 5a contacts with each other but can roll without interference. The plurality of taper rollers 5a are disposed around an inner surface of the bearing outer ring 5b′ in circumferential direction with substantially no gap and any adjoining pair of the taper roller 5a contacts with each other. Accordingly, a retainer for the taper roller bearing 5 is omitted. Because the retainer is omitted, the number of the taper rollers 5a can be increased correspondingly, so that a greater quantity of allowable drive force can be obtained with the same size due to a simple structure of the main roller assemblies 3a, 3b, and 3c.

### Fourth Embodiment

FIG. 13 is a cross-sectional view of main rollers mounted on a lead screw apparatus according to a fourth embodiment. The main roller assemblies 3a, 3b, and 3c according to the fourth embodiment is different from the main roller assemblies 3a, 3b, and 3c according to the first embodiment is in that the main roller 4′ can be shifted in a direction of the rotation axis D relative to the holder 6″ in addition to the cage and the screw shaft 1. For the purpose of this, a thread part 18 is provided on both surfaces of the holder 6″ and the bearing outer ring 5b′ facing each other. The thread part 18 is provided to screw the bearing outer ring 5b′ on the holder 6″ as well as allows the bearing outer ring 5b′ to move in the rotation axis D relative to the holder 6″.

In addition, a fixing nut 17 is provided to be screwed on the thread part 18 on a side of the bearing outer ring 5b′ to function as a double-nut together with the holder 6″ to fix (position) the bearing outer ring 5B′ to prevent the bearing outer ring 5b′ from moving. This allows a quantity of a gap at the point P₃ between the main roller 4′ and the lead screw 1, i.e., so-called backlash, to be adjustable. This structure provides a high robust performance because the backlash or a preload quantity can be appropriately adjusted toward extremely small value after assembling the lead screw apparatus.

Because the bearing outer ring 5b′ can be fixed (positioned) to the holder 6″ with the thread part 18 and the fixing nut 17, the protrusion 6b of the holder 6 shown in FIG. 5 can be omitted. An end surface of the holder 6″ far from the screw shaft 1 and an end surface of the holder 6″ far from the screw shaft 1 can be tapered. Accordingly, the main roller assemblies 3a, 3b, and 3c can be downsized in addition to the holder 6″. This can reduce a dimension of the lead screw apparatus 20 in a diametrical direction, so that a linear actuator having the lead screw apparatus 20 can be downsized.

### Fifth Embodiment

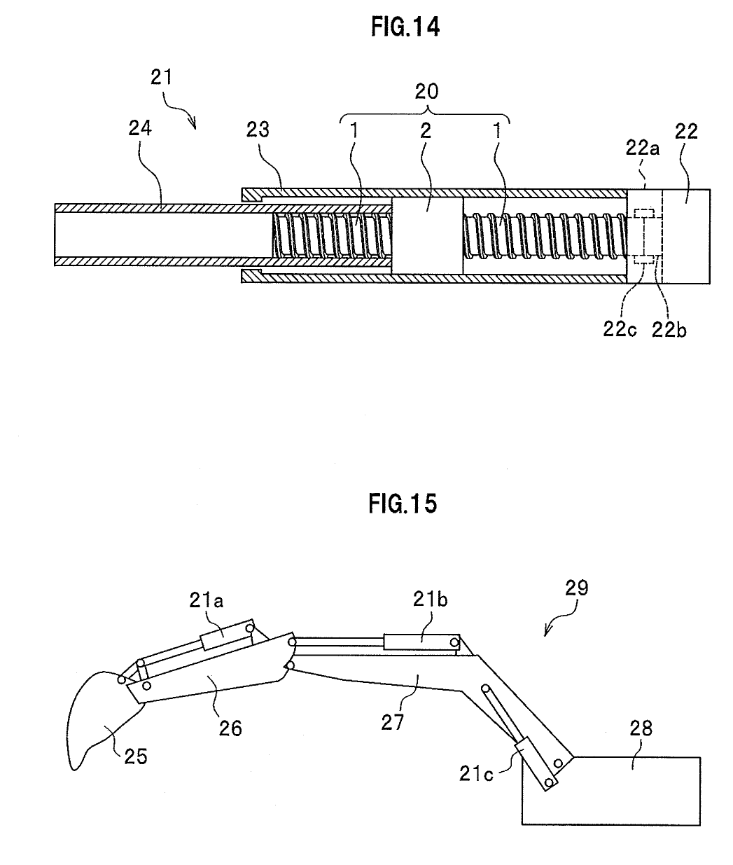

FIG. 14 is a partially cross-sectional and partially exploded view of a linear actuator 21 according to a fifth embodiment. The linear actuator 21 includes any of the lead screw apparatuses 20 according to the first to fourth embodiments. The lead screw apparatus 20 includes the screw shaft 1 and the cage 2, as previously described. The linear actuator 21 includes a rotational motor 22 (case side 22a, rotation shaft 22b, coupling 22c), a linear slider (outer sleeve, output side) 23, and an extendable arm (inner sleeve) 24. The screw shaft 1 is coupled to a rotation shaft 22b (output side) of the motor 22 such that both center axes are aligned with each other and coupled to each other with the coupling 22c. The linear slider 23 (outer sleeve) is connected to a case side 22a of the motor 22. The linear slider (outer sleeve) 23 allows the cage 2 to slide in an axial direction of the screw shaft 1 inside the outer sleeve 23. When the motor 22 rotates, the screw shaft 1 also rotates. Accordingly, the screw shaft 1 and the cage 2 relatively rotate each other, which generates a liner motion of the cage 2 in an axial direction of the screw shaft 1, so that the cage 2 slides in the axial direction of the screw shaft 1 inside of the linear slider (outer sleeve) 23. The motor 22 comprises, for example, an electric motor or an internal combustion engine. The extendable arm (inner sleeve) 24 is connected to the cage 2. As the cage 2 slides, a length of a part of the extendable arm (inner sleeve) 24 exposed to outside can be changed. Accordingly, the linear actuator 21 can be changed in a length in the axial direction of the linear actuator 21.

Particularly, when the lead screw apparatuses according to the second and fourth embodiments are used in the linear actuator 21, a dimension in the diametrical direction of the lead screw apparatus 20 can be reduced, so that a dimension in the diametrical direction of the linear slider (outer sleeve) 23 and a dimension in the diametrical direction of the linear actuator 21 can be reduced.

### Sixth Embodiment

FIG. 15 is an illustration of a shovel (lift apparatus, construction equipment) 29 according to a sixth embodiment of the present invention. The shovel 29 according to the sixth embodiment includes a plurality of linear actuators 21a to 21c having the same structure as that of the linear actuator according to the fifth embodiment. The shovel 29 includes a bucket (movable side) 25, an arm (movable side) 26, a boom (movable side) 27, and an upper rotating body (support side) 28 in addition to the linear actuators 21a to 21c. The bucket 25 is directly, rotatably connected and indirectly connected through the linear actuator 21a to the arm 26. The bucket 25 rotates relative to the arm 26 by extension and contraction motions of the liner actuator 21a. The arm 26 is directly, rotatably connected and indirectly connected through the linear actuator 21b to the arm 27. The arm 26 rotates relative to the boom 27 by extension and contraction motions of the liner actuator 21a. The boom 27 is directly, rotatably connected and indirectly connected through the linear actuator 21c to the upper rotating body 28. The boom 27 rotates relative to the upper rotating body 28 by extension and contraction motions of the liner actuator 21c. The upper rotating body 28 is provided on a lower traveling body (not shown) rotatably. The shovel 29 is exemplified. However, the present invention is applicable to any apparatus that uses a linear motion and, more specifically, uses the linear actuator. For example, the present invention is applicable to a lift apparatus with raising and lowering motions such as construction equipment and an injection molding apparatus and any apparatus having a horizontal motion.

The invention claimed is:

1. A lead screw apparatus comprising:
a screw shaft having a spiral channel on an outer circumferential surface thereof;
a plurality of rollers configured to revolve around the screw with contact with the spiral channel;
a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; and
bearings configured to rotatably support the rollers, each of the bearings including an outer ring supported by the roller cage and an inner ring part connected to each of the rollers, wherein the roller and the inner ring part are formed of an integral one piece member.

2. A lead screw apparatus comprising:
a screw shaft having a spiral channel on an outer circumferential surface thereof;
a plurality of rollers configured to revolve around the screw with contact with the spiral channel;
a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally;
bearings configured to rotatably support the rollers, each of bearings including an outer ring supported by a holder supported by the roller cage, wherein the outer ring includes a protrusion on an outer circumference thereof on a side of the outer circumference closer to the screw shaft, and the holder abuts the protrusion from a side farther than the protrusion from the screw shaft.

3. A lead screw apparatus comprising:
a screw shaft having a spiral channel on an outer circumferential surface thereof;
a plurality of rollers configured to revolve around the screw with contact with the spiral channel; and
a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally;
bearings, each including an outer ring supported by the roller cage and a plurality of tapered rollers, configured to rotatably support the rollers, wherein the tapered rollers are disposed on an inner circumferential surface in a circumferential direction of the outer ring with substantially no gaps so that adjoining rollers of the tapered rollers can contact with each other.

4. A lead screw apparatus comprising:
a screw shaft having a spiral channel on an outer circumferential surface thereof;
a plurality of rollers configured to revolve around the screw with contact with the spiral channel;
a roller cage configured to rotatably support the rollers, the lead screw apparatus providing conversion between a relative rotary motion between the screw shaft and the roller cage and a relative linear motion in axial direction of the screw shaft between the screw shaft and the roller cage bi-directionally; and
bearings, each including an outer ring supported by the roller cage, configured to rotatably support the rollers, wherein the outer ring and the holder include a thread part configured to allow the outer ring to be screwed with the holder to allow the roller to shift in an axial direction of a rotation axis of the roller.

5. The lead screw apparatus as claimed in claim 1, further comprising a holder supporting each of the bearings and a swing pin between the roller cage and the holder configured to swing the holder on a swing axis and rotationally support the holder relative to the roller cage.

6. The lead screw apparatus as claimed in claim 5, wherein
the roller has a side wall shape of a truncated cone so as to contact with a frank surface of the screw shaft through a linear contact line section between the side wall shape and the frank surface, and wherein
when a contact between the roller and the frank surface deviates toward an end of the line contact section, the frank surface and the roller generates a rotation moment around the swing axis which rotates the holder on the swing axis in such a direction that the roller approaches the screw shaft at the other end of the contact line section.

7. The lead screw apparatus as claimed in claim 5, wherein
the roller has a side wall shape of a truncated cone so as to contact with a frank surface of the screw shaft through a linear contact line section between the side wall shape and the frank surface, and wherein
when it is assumed that a representative spiral having a lead which is the same as the screw shaft has is on an imaginary sleeve having an axis aligned with a center axis of the screw shaft and including a point in the contact line section, the swing axis orthogonally intersects a plane orthogonally intersecting at the point a representative spiral crossing the point.

8. The lead screw apparatus as claimed in claim 6, wherein, when it is assumed that a representative spiral, having the same lead as the screw shaft has, is on an imaginary sleeve having an axis aligned with a center axis of the screw shaft and including the point, a center axis of the roller is in parallel with a plane orthogonally intersecting the representative spiral at the point;
the center axis of the roller inclines to a radial direction of the screw shaft toward the contact line section;
the spiral channel of the screw shaft has a trapezoid cross section of which channel width decreases toward the center axis of the screw shaft; and
the roller includes a rolling surface thereon configured to contact with the frank surface to roll on the frank surface, the rolling surface having a side surface of a substantially circular truncated cone shape having an outer diameter on a cross section perpendicular to the axis of the roller which decreases toward the center axis of the screw shaft.

9. The lead screw apparatus as claimed in claim 5, wherein the roller comprises a plurality of rollers, the spiral channel of the screw shaft has a trapezoid cross section of which channel width decreases toward the center axis of the screw shaft, and wherein the number of rollers roll on one of two frank surfaces facing each other across the spiral channel is three.

10. The lead screw apparatus as claimed in claim 9, further comprising a plurality of auxiliary rollers configured to roll on an other of two frank surfaces, each including an auxiliary roller fixing position adjuster, wherein
each of the auxiliary rollers includes a rotation shaft fixed to the roller cage slidably along the rotation shaft; and
the auxiliary roller fixing position adjuster is configured to adjust a position of the auxiliary roller along the rotation shaft to control backrush between the auxiliary roller and the screw shaft in direction of the rotation shaft and a radial direction of the auxiliary roller.

11. A linear actuator comprising:
the lead screw apparatus as claimed in claim 1; and
a rotational motor including a case side and an output side, wherein the output side is rotatable relative to the case side and coupled to the screw shaft, and the rotational motor generates rotation of the screw shaft relative to the roller cage to generate a linear motion of the roller cage.

12. A lift apparatus comprising:
a support side;
a movable side; and
the linear actuator as claimed in claim 11, wherein the case side is connected to the support side and the output side is connected to the movable side.
